(19) United States
(12) Patent Application Publication
(10) Pub. No.: US 2012/0050807 A1
(43) Pub. Date: Mar. 1, 2012

(54) OPERATION CONSOLE WITH IMPROVED SCROLLING FUNCTION, IMAGE FORMING APPARATUS WITH THE OPERATION CONSOLE, AND METHOD OF IMAGE DISPLAY ON THE OPERATION CONSOLE

(75) Inventors: Yoshimune Noda, Osaka (JP); Takeshi Yamaguchi, Osaka (JP); Masato Shiozaki, Osaka (JP)

(73) Assignee: SHARP KABUSHIKI KAISHA, Osaka (JP)

(21) Appl. No.: 13/217,880

(22) Filed: Aug. 25, 2011

(30) Foreign Application Priority Data
Aug. 27, 2010 (JP) 2010-190417

(51) Int. Cl. G09G 5/00; G06F 3/12

(52) U.S. Cl. 358/1.15; 345/650

(57) ABSTRACT

In order to provide an operation console allowing highly efficient movement of displayed images, a CPU controlling a touch-panel display causes a display panel to display an image edition mode screen image including preview images of a plurality of pages in a movable manner. If it is detected that any of the plurality of preview images is in a selected state (first press) based on a user operation on the touch-panel, determination is made as to whether an instruction (second press and flick operation) to move the plurality of preview images other than the selected preview image has been issued, based on a user operation on the touch-panel. If it is determined that the instruction has been given, the plurality of preview images other than the selected preview image are scrolled.

### CROSS-REFERENCE TO RELATED APPLICATION

This nonprovisional application claims priority under 35 U.S.C. §119(a) on Patent Application No. 2010-190417 filed in Japan on Aug. 27, 2010, the entire contents of which are hereby incorporated by reference.

### BACKGROUND OF THE INVENTION

1. Field of the Invention

The present invention relates to an operation console receiving a user instruction using a display device, an image forming apparatus having the operation console, and to a method of displaying images on the operation console. More specifically, the present invention relates to an improvement of a technique for scrolling an image when the image displayed on a display screen is to be moved.

2. Description of the Background Art

Conventionally, in a touch-panel-integrated display device or the like, a technique of moving a displayed image or scrolling a display area has been known to allow display of more information on a limited display area.

By way of example, Japanese Patent Laying-Open No. 7-44319 discloses a cursor movement instruction input device provided with a panel switch. In the cursor movement instruction input device, when a user presses and thereby moves the panel switch, data of the center of pressed position are successively stored and the direction of movement is determined. Based on the result of determination, cursor movement is controlled.

Japanese Patent Laying-Open No. 2002-333951 discloses an input device, in which one-dimensional touch sensors are arranged in horizontal and vertical directions of a display, and positions of a finger operating on the one-dimensional sensors are successively calculated. In this device, based on the calculated position information, velocity of scrolling an image, menu or the like on the display is determined, and the display image in accordance with the determined scrolling velocity is successively displayed on the display.

Japanese Patent Laying-Open No. 2006-302184 discloses a portable telephone terminal with an operating device including a multiple key operators and a touch-panel formed on an area covering all key operators or spaces between the multiple key operators. The portable telephone terminal scrolls a display based on the direction and amount of movement when the user traces the surface of operating device with, for example, his/her finger.

In any of the techniques disclosed in the prior art references above, what can be done is simply to select and move or scroll only one displayed image. Therefore, when the user wishes to have an image displayed on a display screen of a small size moved to a desired position, it has been difficult to select an image and, therefore, the displayed image cannot be moved efficiently. Particularly when an image is to be moved by dragging, it has been difficult to continuously drag the image.

### SUMMARY OF THE INVENTION

Therefore, it is preferable to provide an operation console having a display screen that allows efficient movement of a displayed image, as well as an image forming apparatus including the operation console.

According to a first aspect, the present invention provides an operation console including a display device having a display screen, and a touch-panel arranged superposed on the display screen for receiving a user operation on the display screen. The operation console includes: a display control device controlling the display device such that a plurality of images are displayed on the display screen; a detecting device detecting any of the plurality of images being selected, based on a user operation on the touch-panel; a first determining device for determining, while selection of any of the plurality of images is being detected by the detecting device, whether or not an instruction for moving images other than the selected image among the plurality of images has been given, based on a user operation on the touch-panel; and a scrolling device for scrolling and displaying the images other than the selected image among the plurality of images, in response to a determination by the first determining device that the instruction for moving has been given.

The detecting device detects selection of any of the plurality of images displayed on the display screen by the user operation on the touch-panel. While the detecting device is detecting that any of the images is being selected, the first determining device determines whether or not an instruction for moving an image other than the selected image is given, based on the user operation on the touch-panel. In response to the determination by the first determining device that the moving instruction has been given, the scrolling device scrolls and displays the images other than the selected image among the plurality of images.

When an image displayed on the display screen of a small size is to be moved to a desired position, the selected image is displayed not scrolled on the display screen, while other images are scrolled. It is unnecessary to move the selected image. On the other hand, in order to scroll other images, it is unnecessary to select a specific image among the images to be scrolled. Thus, the operation for scrolling is easy. As a result, the displayed image can be moved with high efficiency. Further, it is possible to use one finger (for example, a finger of one hand) to select an image and to use another finger (for example, a finger of the other hand) to move other images. Since instructions related to movement of displayed images can be issued using two fingers, it is possible for the user to move the image or images in a simple manner.

Preferably, the operation console further includes a second determining device for determining, while selection of any of the plurality of images is being detected by the detecting device, whether or not the selected image among the plurality of images is displayed stationary, based on a user operation on the touch-panel. The first determining device determines whether or not the instruction for moving has been given, if it is determined by the second determining device that the selected image is displayed stationary.

While the selected image is displayed stationary, the first determining device determines whether or not an instruction for moving an image other than the selected image among the plurality of images is given. It is possible to prevent unintended scrolling of an image while an image is being selected and moved, by an erroneous operation by the user. Thus, the image can be moved with high efficiency.

More preferably, the operation console further includes a second determining device for determining, while selection of any of the plurality of images is being detected by the detecting device, whether or not the selected image is displayed stationary at a predetermined position, based on a user operation on the touch-panel. The first determining device determines whether or not the instruction for moving has been given, if it is determined by the second determining device that the selected image is displayed stationary at a predetermined position.

In this manner, while the selected image is displayed stationary at the predetermined position, whether or not an instruction for moving an image or images other than the selected image has been given is determined. It is possible to prevent unintended scrolling of a plurality of images while the selected image is not displayed stationary at the predetermined position by an erroneous operation by the user. Thus, the image can be moved with high efficiency.

More preferably, the predetermined position is an end portion of the display screen. Thus, it becomes easier for the user to make an instruction for moving a plurality of images other than the image in the selected state, by the operation on the touch-panel. Thus, the image can be moved with higher efficiency.

More preferably, the operation console further includes an automatic scrolling device for scrolling the images other than the selected image among the plurality of images in a predetermined, prescribed direction at a predetermined initial speed, if it is determined by the second determining device that the selected image is displayed stationary at the predetermined position.

In this manner, when the selected image is displayed stationary at the predetermined position, images other than the selected image among the plurality of images are automatically scrolled. Therefore, the image can be moved with higher efficiency. Further, by determining the prescribed position beforehand, automatic scroll can be started with high efficiency.

More preferably, the operation console further includes a deciding device deciding direction of scrolling, duration of scrolling, amount of scrolling or initial speed of scrolling by the scrolling device, based on a user operation on the touch-panel. It is noted, however, that if two of these are determined, the remaining value or values may be found through calculation and, therefore, what is required is to determine the least necessary values in accordance with the desired manner of control. In this manner, the user can scroll the selected image among the plurality of images in a desired direction at a desired initial speed. Particularly, when the speed of auto-scroll is too slow or too fast, it is possible to adjust the direction and speed of scrolling and, hence, user convenience can be improved.

More preferably, the first determining device determines whether or not the instruction for moving has been given, based on a flick operation by the user on the touch-panel. The operation console further includes a flick velocity detecting device for detecting velocity (that is, direction and speed) of the flick operation by the user on the touch-panel. The deciding device decides the initial speed of scrolling, duration of scrolling, amount of scrolling or the direction of scrolling, based on the detected velocity. Therefore, it is possible for the user to scroll the images other than the selected image among the plurality of images easily at a desired velocity. Thus, user convenience can be improved.

The image forming apparatus may further include a storage device for storing a plurality of image data items corresponding to the plurality of images in order. The display control device controls the display device such that the plurality of images are displayed on the display screen in an order in accordance with the order of corresponding image data items. The operation console may further include an order changing device, responsive to detection from an output of the detecting device that selection of the selected image is cancelled, for changing the order of storage of the plurality of image data items in the storage device, in accordance with the order of display arrangement of the plurality of images displayed on the display screen at that time.

The image forming apparatus in accordance with the second aspect of the present invention includes the operation console as described above and, therefore, the order of arrangement of images as the objects of image formation may be changed easily. Thus, an image forming apparatus highly convenient for the user can be provided.

According to a third aspect, the present invention provides a display method in an operation console including a display device having a display screen, and a touch-panel arranged superposed on the display screen for receiving a user operation on the display screen, including: the display step of controlling the display device such that a plurality of images are displayed; the detecting step of detecting any of the plurality of images being selected, based on a user operation on the touch-panel; the determining step of determining, while selection of any of the plurality of images is being detected at the detecting step, whether or not an instruction for moving images other than the selected image among the plurality of images has been given, based on a user operation on the touch-panel; and the scrolling step of scrolling the images other than the selected image among the plurality of images, if it is determined at the determining step that the instruction for moving has been given.

In this manner, by a user operation on the touch-panel, any of the plurality of images displayed on the display screen is selected. If an instruction for moving an image or images other than the selected image among the plurality of images is given, the image or images other than the selected image are scrolled. As a result, when a displayed image on a display screen of a small size is to be moved to a desired position, the displayed image can be moved with high efficiency. Thus, user convenience can be improved.

According to the present invention, by a user operation on the touch-panel, any of the plurality of images displayed on the display screen is selected, and when an instruction is given to move the plurality of images other than the image in the selected state, the plurality of images other than the image in the selected state are scrolled. As a result, when a displayed image on a display screen of a small size is to be moved to a desired position, the displayed image can be moved with high efficiency. Thus, user convenience can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an outer appearance of an image forming apparatus in accordance with an embodiment of the present invention.

FIG. 2 schematically shows an inner configuration of the image forming apparatus shown in FIG. 1.

FIG. 3 is a block diagram showing an electrical configuration of the image forming apparatus shown in FIG. 1.

FIG. 4 shows a basic layout configuration of a basic screen image for various operational modes.

FIG. 5 shows an example of a copy mode basic screen image.

FIG. 6 shows an example of an image edition mode screen image.

FIG. 7 is a flowchart representing a control structure of a computer program realizing a page order changing process.

FIGS. 8 to 12 illustrate operations of the image forming apparatus when a page order is to be changed.

FIG. 13 is a flowchart representing a control structure of a computer program realizing the page order changing process in accordance with a first modification of an embodiment of the present invention.

FIG. 14 is a flowchart representing a control structure of a computer program realizing the page order changing process in accordance with a second modification of an embodiment of the present invention.

### DESCRIPTION OF THE PREFERRED EMBODIMENTS

In the following description, the same components are denoted by the same reference characters. Their names and functions are also the same. Therefore, detailed description thereof will not be repeated.

[Image Forming Apparatus 100]

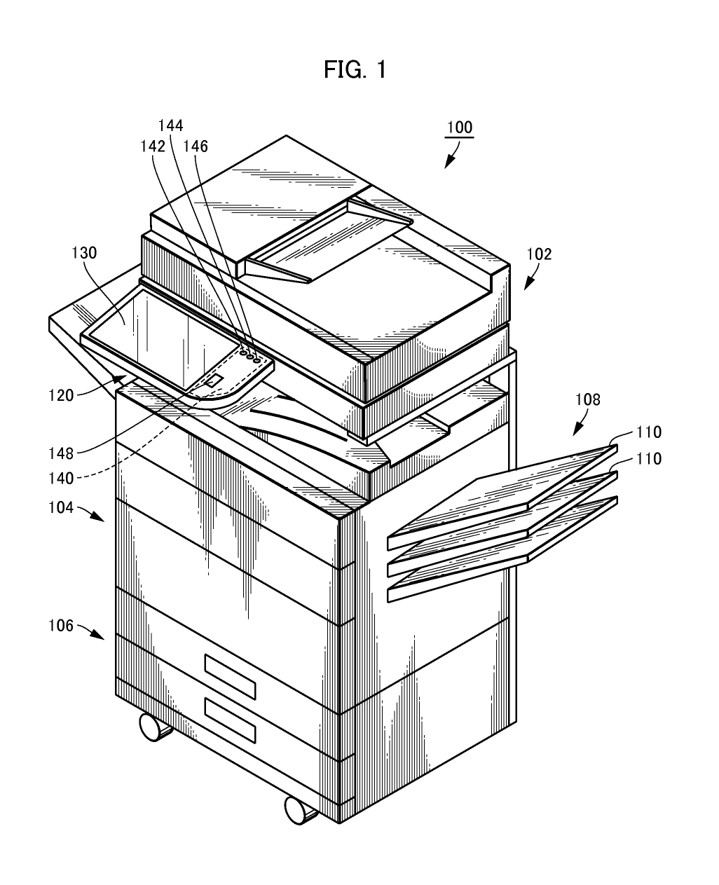

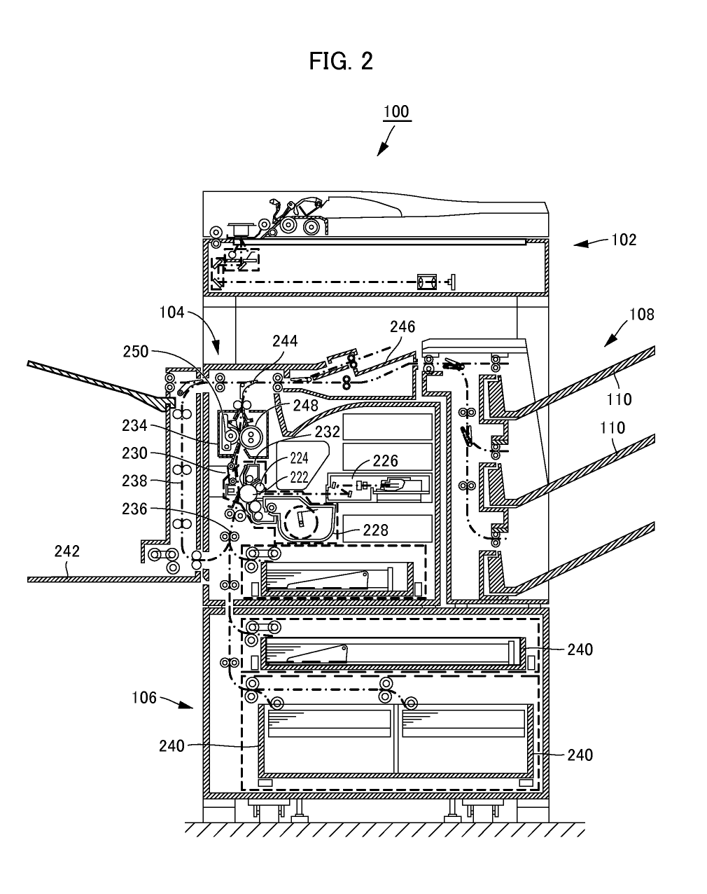

Referring to FIGS. 1 to 3, an image forming apparatus 100 in accordance with an embodiment of the present invention is a Multifunction Printer (MFP) having scanner function, copy function, facsimile (hereinafter denoted as FAX) function and the like. It is possible for the user to set the operational mode of image forming apparatus 100 to any of the scanner mode, copy mode and FAX mode. Image forming apparatus 100 executes processes corresponding to the set operational mode.

<Hardware Configuration>

[Operation Unit 120 of Image Forming Apparatus 100]

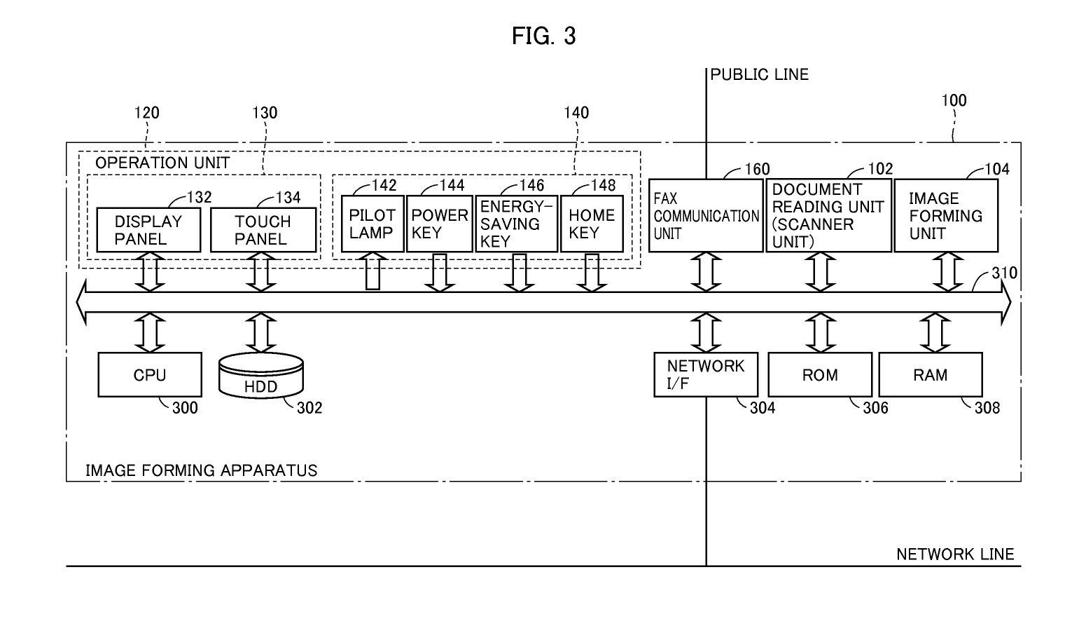

Referring to FIGS. 1 and 3, image forming apparatus 100 includes an operation unit 120. Operation unit 120 is formed of a plate-shaped panel provided in an inclined manner to be easily viewable by the user on an upper front side of image forming apparatus 100. Operation unit 120 includes a touch-panel display 130 arranged from the center to the left side on the surface of operation unit 120 and a display operation unit 140 arranged on the right side on the surface of operation unit 120. Touch-panel display 130 and display operation unit 140 are held in one housing and operation unit 120 is formed as one unit as a whole. Operation unit 120 communicates with a CPU 300, which will be described later, through an input/output interface (not shown).

Touch-panel display 130 is a touch-panel-integrated liquid crystal display device, including a display panel 132 and a touch-panel 134 stacked on display panel 132. On display panel 132, a home screen image (not shown) allowing selection of a desired operational mode from a plurality of operational modes executable by image forming apparatus 100, and a basic screen image allowing setting of various functions and parameters in various operational modes are displayed. The display operation of display panel 132 is controlled by CPU 300 executing a prescribed program. By way of example, on a screen image displayed on display panel 132, software keys are displayed. When the user presses any of the software keys, touch-panel 134 detects the pressed position. CPU 300 compares the display position of the software key and the pressed position of the touch-panel on a program, and based on the result of comparison, selects an operational mode, sets various functions and parameters and issues an operation instruction. Though the size and shape of touch-panel display 130 are not specifically limited, one having a rectangular shape of 1024 pixels×600 pixels of landscape orientation may be used.

Display operation unit 140 includes a pilot lamp 142 and various hardware keys such as a power key 144, an energy saving key 146 and a home key 148. Pilot lamp 142 includes, for example, an LED (Light Emitting Diode), and it is on when the power of image forming apparatus 100 is on.

Power key 144 turns on/off the power of image forming apparatus 100.

Energy saving key 146 is for issuing an instruction to make a transition from a normal mode to an energy saving mode, or from the energy saving mode to the normal mode. Transition to the energy saving mode occurs not only when energy saving key 146 is pressed but also when a prescribed time passes without any user operation. The normal mode refers to a state in which image forming apparatus 100 is powered on and all operational modes are executable. The energy saving mode refers to a state in which image forming apparatus 100 is powered on and only some limited operational modes (for example, only facsimile reception) are executable to handle an unexpectable event.

Home key 148 is to issue an instruction to make a transition to the home screen image (not shown). By way of example, when the user presses home key 148, the home screen image including, for example, an icon as a software key for selecting the copy mode, and an icon as a software key for selecting the FAX mode, is displayed on display panel 132.

By selecting operation of a user selecting any of the icons displayed on the home screen image, any of the operational modes such as the copy mode or the FAX mode is selected. In response, a basic screen image of the selected operational mode is displayed on display panel 132. The selecting operation mentioned above is not specifically limited, and it may be any common operation made in the field of art. The operation may include a touch operation (an input operation based on a position of pressing by the user) and a gesture operation (an input operation based on a trajectory of operation by the user).

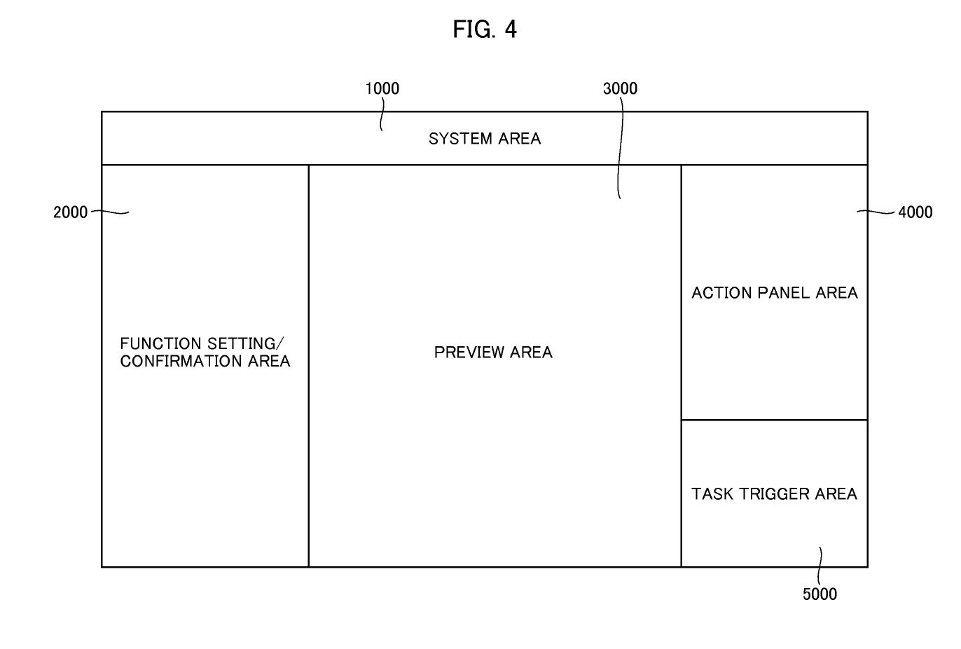

Referring to FIG. 4, the basic screen image of each operational mode includes five areas, that is, a system area 1000, a function setting/confirmation area (hereinafter referred to as “function selecting area”) 2000, a preview area 3000, an action panel area 4000 and a task trigger area 5000. These five areas are arranged in the following manner, in accordance with a basic layout. Specifically, system area 1000 is arranged at the top of basic screen image. Preview area 3000 is arranged at the center of basic screen image. Function selecting area 2000 is arranged on the left side of preview area 3000 in the basic screen image. Action panel area 4000 is arranged on the upper right side of preview area 3000 in the basic screen image. Task trigger area 5000 is arranged on the lower right side of preview area 3000 in the basic screen image. The five areas forming the basic screen image of each operational mode and the basic layout are common in all operational modes.

As an example of the basic screen image of each operational mode describe above, the basic screen image for the copy mode will be described in the following.

[Copy Mode Basic Screen Image 7100]

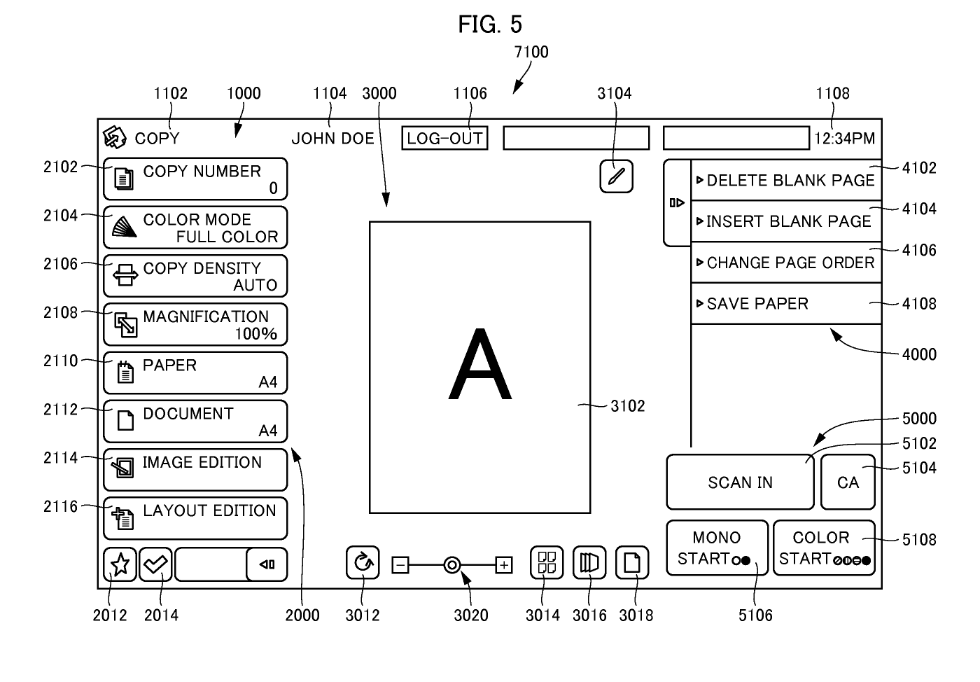

Referring to FIG. 5, on system area 1000 of copy mode basic screen image 7100, a character sequence “COPY” 1102 indicating the copy mode, a logged-in user name 1104, a log out key 1106 requesting execution of log-out and current time 1108 are displayed.

On function selecting area 2000 of copy mode basic screen image 7100, various setting keys for changing various functions and conditions such as parameters related to the copy mode are displayed. In the present embodiment, as various setting keys, a key 2012 for changing the number of copies, a key 2014 for switching color mode, a key 2106 for changing copy density, a key 2108 for changing copy magnification, a key 2110 for changing the size of recording paper to be used, a key 2112 for changing document size, a key 2114 for image edition and a key 2116 for layout edition are displayed. If any of the setting keys 2102 to 2116 is touched by the user, a setting screen image corresponding to the pressed key (such as density setting screen image, magnification setting screen image or document setting screen image) is displayed. On setting keys 2102 to 2116 described above, simple pictures and character sequences representing the function corresponding to each key are displayed. By way of example, on key 2102, a picture representing the function of changing the number of copies, a character sequence of “copy number” and the numerical value representing the set number of copies are displayed.

Below the setting keys 2102 to 2116 described above in function selecting area 2000, change keys 2012 and 2014 are displayed, for changing the display style of setting keys 2102 to 2116. Change key 2012 is for displaying setting keys related to functions registered as “favorites.” Change key 2014 is for displaying only the setting keys related to a function of which setting has been changed. In the present embodiment, it is assumed that change key 2012 is selected and on function selecting area 2000, setting keys related to the functions registered as “favorites” in the copy mode are displayed.

If not all setting keys to be displayed can be displayed in function selecting area 2000, various setting keys are displayed in upward/downward scrollable manner. Here, the display positions of change keys 2012 and 2014 are fixed. The user may switch the display portion of various setting keys upward/downward by, for example, a flick operation in upward/downward direction on the screen image. The flick operation refers to an operation of lightly sweeping a display portion to a prescribed direction. In accordance with the velocity of finger movement at this time (that is, direction and speed of finger movement), the manner of scrolling can be changed, as will be described later.

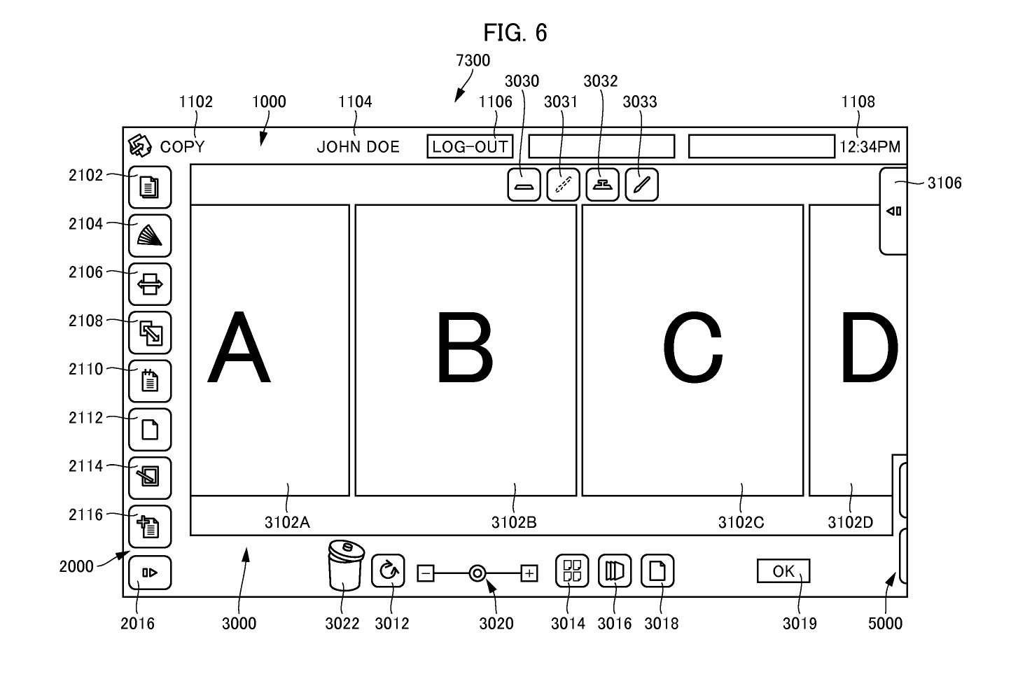

On preview area 3000 of copy mode basic screen image 7100, a preview image 3102 based on the image data such as the scan data read by document reading unit 102 is displayed. The image data refers to data as a source of preview images, and the image data are stored in a prescribed storage device in an order in accordance with certain sequence. Typically, the image data are stored in the storage device in the order of reading the images. In preview area 3000, above preview image 3102, an edition key 3104 for issuing an instruction to make a transition to image edition mode screen image 7300 (see FIG. 6) is displayed.

On preview area 3000, below preview image 3102, preview change keys 3012 to 3018 and a slider 3020 are displayed. Change key 3012 is for rotating preview image 3102. Change keys 3014 to 3018 are for changing the display style of preview image 3102. When change key 3014 is selected, on preview area 3000, preview images 3102 of a plurality of pages are displayed in reduced size. When change key 3016 is selected, on preview area 3000, preview images 3102 of a plurality of pages are displayed in stacked manner. When change key 3018 is selected, on preview area 3000, only a preview image 3102 of one page is displayed. In the present embodiment, it is assumed that change key 3018 has been selected. Slider 3020 is used for enlarging/reducing the size of preview image 3102.

On action panel area 4000 of copy mode basic screen image 7100, various execution keys for executing recommended functions in the copy mode are displayed. The recommended functions refer to functions selected in the past in combination with the function selected by the user. In the present embodiment, as the various execution keys mentioned above, a key 4102 for deleting image data of a blank page from image data of a plurality of pages, a key 4104 for inserting image data of a blank page to the image data of a plurality of pages, a key 4106 of changing page order of the image data of a plurality of pages, and a key 4108 for executing a page saving function are displayed.

On task trigger area 5000 of copy mode basic screen image 7100, a scan-in key 5102, a clear-all key 5104, a monochrome start key 5106 and a color start key 5108 are displayed. Scan-in key 5102 is for starting execution of a scan-in process in which a document is scanned and a preview image 3102 based on the obtained scan data is displayed on preview area 3000. Clear-all key 5104 cancels all functions and parameters of which settings have been changed, and returns the settings to the default state. Monochrome start key 5106 is for starting execution of a monochrome copy process in which a document is scanned and a monochrome copy is taken based on the obtained image data (or on scan data obtained by the scan-in process). Color start key 5108 is for starting a color copy process in which a document is scanned and a color copy is taken based on the obtained image data (or on scan data obtained by the scan-in process). As described above, in the present specification, the image data scanned by the scan-in process is referred to as “scan data” and distinguished from other image data.

[Image Edition Mode Screen Image 7300]

As described above, when the user touches edition key 3104 displayed on preview area 3000 of copy mode basic screen image 7100, image edition mode screen image 7300 is displayed on display panel 132.

Referring to FIG. 6, at the top of image edition mode screen image 7300, system area 1000 having the same configuration as in copy mode basic screen image 7100 is provided.

From the central portion to the right side of image edition mode screen image 7300, preview area 3000 enlarged than in the copy mode basic screen image 7100 is provided. On preview area 3000, preview images 3102A to 3102D (hereinafter also generally referred to as “preview image 3102”) of a plurality of pages are displayed, allowing scrolling in the left/right direction of the screen image. Preview images 3102A to 3102D of the plurality of pages have page numbers allotted in ascending order from the left to the right side of the screen image. Specifically, preview images 3102A to 3102D are arranged and displayed in accordance with the page order (order of reading). The page order is the same as the order of read image data in the storage device. In preview area 3000, below the preview images 3102 of the plurality of pages, an OK key 3019 requesting cancellation of the image edition mode, and a trash bin icon 3022 for deleting image data and the like are displayed, in addition to the preview change keys 3012 to 3018 and slider 3020 described above. In preview area 3000, above the preview images 3102 of the plurality of pages, various image edition keys 3030 to 3034 including an eraser key and a pencil key are displayed.

In image edition mode screen image 7300, on the left side of preview area 3000, a function selecting area 2000 is displayed, reduced than in the copy mode basic screen image 7100. On various setting keys 2012 to 2116 displayed in function selecting area 2000, only the simple pictures representing functions corresponding to respective keys are displayed. Therefore, various setting keys 2102 to 2116 come to have smaller sizes than in copy mode basic screen image 7100. In function selecting area 2000, below various setting keys 2102 to 2116, an arrow key 2016 requesting display of change keys 2012 and 2014 is displayed.

On the upper right end of preview area 3000, a tab key 3106 is displayed. When the user flicks tab key 3106 from the right to the left side of the screen image, action panel area 4000 having the same configuration as in copy mode basic screen image 7100 is displayed in front of preview area 3000.

On the lower right end of preview area 3000, only a part of task trigger area 5000 having the same configuration as in copy mode basic screen image 7100 is displayed in such a manner as to allow recognition of the task trigger area. Therefore, in image edition mode screen image 7300, various keys 5102 to 5108 included in task trigger area 5000 are unusable.

[Overall Configuration of Image Forming Apparatus 100]

Referring to FIGS. 1 to 3, image forming apparatus 100 includes, in addition to operation unit 120 described above, a document reading unit 102, an image forming unit 104, a paper feed unit 106, and a paper discharge unit 108. In the following, operations in the copy mode and the FAX mode will be described, to illustrate the overall hardware configuration of image forming apparatus 100.

—Copy Mode—

In the present embodiment, in the copy mode, document reading unit 102 and image forming unit 104 mainly operate to execute any of the scan-in process, mono-copy process and color copy process.

(Scan-in Process)

When the copy mode is selected on the home screen image (not shown) and scan-in key 5102 is touched, a document placed manually or by an ADF on a platen is read as scan data by document reading unit 102. The read scan data is input to CPU 300. CPU 300 performs various image processing operations on the input scan data, and displays preview image 3102 based on the scan data, on preview area 3000 of copy mode basic screen image 7100. At this time, the image data is temporarily stored in a storage device (for example, in an RAM (Random Access Memory) 308 shown in FIG. 3). The image data is stored in such a manner that the order of reading can be reproduced (that is, in the order of reading).

(Normal Monochrome Copy Process and Color Copy Process)

When the copy mode is selected on the home screen image (not shown) and a monochrome start key 5106 or a color start key 5108 is touched while the scan-in process described above is not being done, a document placed manually or by an ADF on a platen is read as image data by document reading unit 102. The read image data is input to CPU 300 implemented, for example, by a microcomputer, shown in FIG. 3, and subjected to various image processing operations. Then, the image data is output to image forming unit 104.

Image forming unit 104 is for printing an image of the document based on the image data on a recording medium (in most cases, on a sheet of recording paper). Image forming unit 104 includes a photoreceptor drum 222, a charger 224, a laser scanning unit (hereinafter denoted as LSU) 226, a developer 228, a transfer device 230, a cleaning device 232, a fixing device 234 and a neutralizer, not shown.

In image forming unit 104, a main feeding path 236 and a reverse feeding path 238 are provided. Paper feed unit 106 draws out sheets of recording paper stacked on a paper feed cassette 240 or on a manual feed tray 242 one by one, and feeds the sheet of paper to main feeding path 236 of image forming unit 104. The sheet of recording paper fed from paper feed unit 106 is fed along main feeding path 236.

While the sheet of recording paper is fed along main feeding path 236, the sheet passes between photoreceptor drum 222 and transfer device 230, and further passes through fixing device 234, whereby printing is done on the sheet of recording paper.

Photoreceptor drum 222 rotates in one direction, and its surface is cleaned by cleaning device 232 and the neutralizer and, thereafter, uniformly charged by charger 224.

LSU 226 modulates the laser beam based on the image data to be printed, and repeatedly scans the surface of photoreceptor drum 222 with the modulated laser beam in a main scanning direction, whereby an electrostatic latent image is formed on the surface of photoreceptor drum 222.

Developer 228 develops the electrostatic latent image by supplying toner to the surface of photoreceptor drum 222, and thus, a toner image is formed on the surface of photoreceptor drum 222. When the monochrome copy process is executed, developer 228 supplies monochrome toner. When the color copy process is executed, developer 228 supplies color toner including yellow (Y), magenta (M), cyan (C) and black (K).

Transfer device 230 transfers the toner image on the surface of photoreceptor drum 222 to the sheet of recording paper passing between transfer device 230 and the photoreceptor drum 222.

Fixing device 234 includes a heating roller 248 for heating the sheet of recording paper and a pressure roller 250 for pressing the sheet of recording paper. As the sheet of recording paper is heated by heating roller 248 and pressed by pressure roller 250, the toner image that has been transferred to the sheet of recording paper is fixed on the sheet. A heater provided in heating roller 248 is heated by electric power supplied to fixing device 234 and controlled such that temperature of heating roller 248 attains to an appropriate temperature for fixing.

At a position of connection between main feeding path 236 and reverse feeding path 238, a separation pawl 244 is arranged. When printing is done only on one side of the sheet of recording paper, separation pawl 244 is so positioned that the sheet of recording paper fed from fixing device 234 is guided to paper discharge tray 246 or a paper discharge unit 108.

When printing is done on both sides of the sheet of recording paper, separation pawl 244 is turned to a prescribed direction, so that the sheet of recording paper is guided to reverse feeding path 238. The sheet of recording paper passes through reverse feeding path 238, turned upside-down and again fed to main feeding path 236, and while it is again fed along main feeding path 236, printing is done on its rear surface, and thereafter the sheet is guided to paper discharge tray 246 or to paper discharge unit 108.

The sheet of recording paper printed in the above-described manner is guided to paper discharge tray 246 or to paper discharge unit 108, and discharged to paper discharge tray 246 or to any of paper discharge trays 110 of paper discharge unit 108.

Paper discharge unit 108 may perform a process of sorting a plurality of printed sheets of paper to be output to different discharge trays 110, a process of punching each sheet of recording paper or a process of stapling the sheets of recording paper. Assume that a number of copies of the printing are to be prepared. In that case, sheets of recording paper are sorted and discharged to paper discharge trays 110 such that each tray 110 contains each set of printed sheets, and the set of printed sheets in each tray 110 is stapled or punched.

(Monochrome Copy Process and Color Copy Process after Scan-in Process)

When the copy mode is selected on the home screen image (not shown), the scan-in process described above is done and thereafter, monochrome start key 5106 or a color start key 5108 may be touched. In such a case, scanning of the document image and the image processing on the image data described above do not take place, and image forming unit 104 performs the image forming process in the similar manner as described above on the scan data that has been read in the scan-in process and stored temporarily in the storage device.

—FAX Mode—

In the present embodiment, in the FAX mode, the scan-in process and the FAX transmission process are executed by the operations of document reading unit 102 and FAX communication unit 160 shown in FIG. 3. Further, the FAX communication process is executed by the operation of FAX communication unit 160. Further, the FAX reception process is executed by the operations of FAX communication unit 160 and image forming unit 104.

(Scan-in Process)

When the FAX mode is selected on the home screen image (not shown) and the scan-in key (not shown) displayed on the basic screen image of FAX mode is touched, a document placed manually or by an ADF on a platen is read as scan data by document reading unit 102. The read scan data is input to CPU 300. CPU 300 performs various image processing operations on the input scan data, and displays a preview image base on the image data, on preview area 3000 of FAX mode initial screen image (not shown). Here, the image data is temporarily stored in a storage device (for example, in RAM 308 shown in FIG. 3).

(Normal Fax Transmission Process)

When the FAX mode is selected on the home screen image (not shown) and a start key (not shown) displayed on the FAX mode basic screen image (not shown) is touched while the scan-in process is not being done, a document placed manually or by an ADF on a platen is read as image data by document reading unit 102. The read image data is input to CPU 300, and subjected to various image processing operations. Then, the image data is output to FAX communication unit 160.

On the other hand, when the FAX mode is selected on the home screen image (not shown), the scan-in process described above is done and thereafter, the start key (not shown) may be touched. In such a case, scanning of the document image and the image processing on the image data described above do not take place, and the scan data that has been read in the scan-in process and temporarily stored in the storage device is output to FAX communication unit 160.

FAX communication unit 160 of image forming apparatus 100 on the transmitting side connects a transmitting side line to a designated transmission destination, converts the input image data or scan data to communication data in compliance with facsimile transmission standard, and transmits the converted data to a facsimile machine (such as an image forming apparatus 100 having the facsimile function) on the receiving side.

(FAX Communication Process)

When the line is connected, a FAX communication unit 160 of image forming apparatus 100 on the receiving side detects a communication request signal from FAX communication unit 160 of image forming apparatus 100 on the transmitting side, and transmits an acknowledgement signal. Thereafter, by way of example, FAX communication units 160 on the transmitting and receiving sides pass performance information supported by transmitting side and receiving side, determine highest possible speed of communication and method of coding/code correction of image data, and set the method of communication of modems. Then, using the image signal format in compliance with the communication method, data is transmitted from FAX communication unit 160 of image forming apparatus 100 on the transmitting side to FAX communication unit 160 of image forming apparatus 100 on the receiving side. When transmission ends, the line is disconnected.

(Fax Reception Process)

FAX communication unit 160 of image forming apparatus 100 on the receiving side converts the received data to image data and passes the data to an image forming unit 104. The received data may be converted to image data at the image forming unit 104. The image forming unit 104 prints an image of a document based on the image data converted from the received data on a sheet of recording paper, in a manner similar to the operation in the copy mode described above.

<Electrical Configuration>

Referring to FIG. 3, image forming apparatus 100 includes: operation unit 120 allowing setting of various functions and parameters related to various operational modes such as the copy mode and the FAX mode; an ROM (Read Only Memory) 306 for storing a program or programs; an HDD 302 including a hard disk providing a non-volatile storage area capable of storing programs and data even when power supply is shut off and an RAM 308 providing a storage area when a program is executed.

Image forming apparatus 100 further includes a bus 310 connected to document reading unit 102, image forming unit 104, FAX communication unit 160, operation unit 120, HDD 302, ROM 306, RAM 308, and network I/F 304; and CPU 300 connected to bus 310 and controlling these units and components for realizing general functions of the image forming apparatus.

In HDD 302, various data such as the image data scanned by document reading unit 102 are stored. ROM 306 stores computer programs for realizing general operations of image forming apparatus 100 as well as a computer program for realizing the page order changing process, which will be described later. ROM 306 further stores basic screen image data for displaying basic screen images for various operational modes such as the copy mode and the FAX mode.

RAM 308 provides a function of a working memory temporarily storing results of operations and processes by CPU 300, and a function of a frame memory for storing image data. CPU 300 executes control related to various functions of image forming apparatus 100 in accordance with computer programs stored in ROM 306. Specifically, control of various units including document reading unit 102, image forming unit 104, touch-panel display 130 and display operation unit 140 of operation unit 120, HDD 302, ROM 306 and RAM 308 is realized by CPU 300 executing a prescribed computer program.

As shown in FIG. 3, a public line is connected for transmitting/receiving image data, to FAX communication unit 160 of image forming apparatus 100. To network I/F 304, a network line is connected. To the network line, a computer or the like using image forming apparatus 100 as a network-supported printer, or a computer or the like identified by a URL (Uniform Resource Locator) designated through the Internet may be connected. When connected to the Internet through the network line, image forming apparatus 100 can obtain necessary information through the Internet.

<Software Configuration>

(Page Order Changing Process)

The program for realizing the page order changing process is activated when image edition mode screen image 7300 described above is displayed on display panel 132.

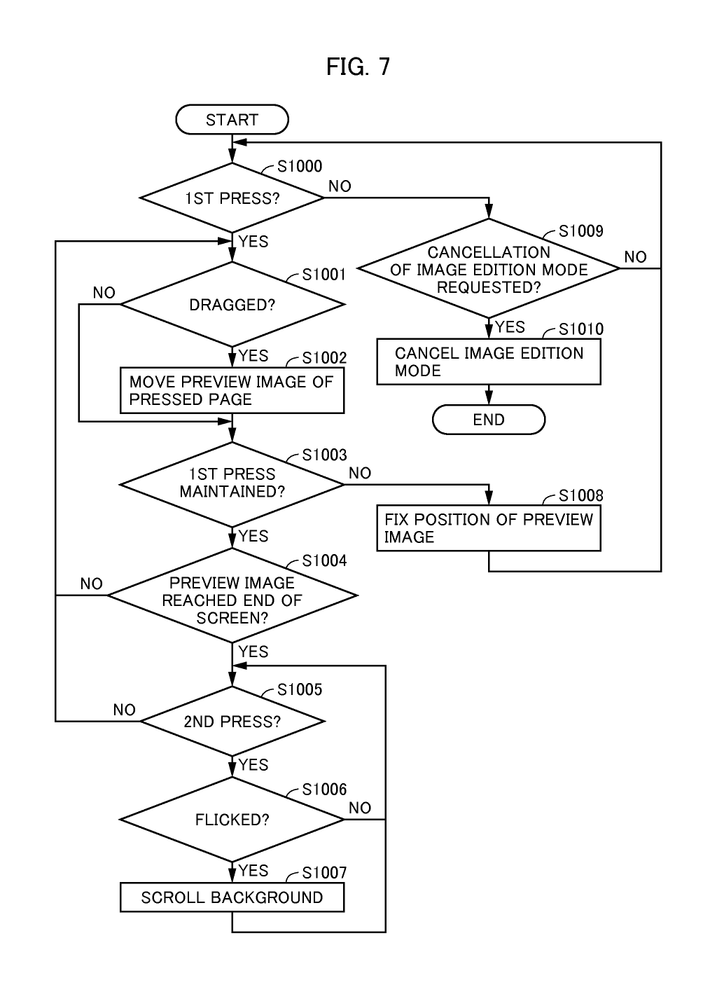

Referring to FIG. 7, the program includes a step S1000 of determining whether or not there is a first press. Here, the first press refers to a pressing by the user of a portion corresponding to any of the preview images 3102 of a plurality of pages displayed on preview area 3000 of image edition mode screen image 7300. The image at the pressed portion is set to a selected state.

The program further includes a step S1001, executed if it is determined at step S1000 that there has been a first press (YES), of determining whether or not a drag operation has been done on preview image 3102 of the pressed page. Here, the drag operation refers to an operation of pressing a display portion (here, preview image 3102) with a finger and, with the portion kept pressed, moving the finger on the screen.

The program further includes: a step S1002, executed if it is determined at step S1001 that the drag operation has been made (YES), of moving the preview image 3102 of the pressed page in accordance with the dragged trajectory; and a step S1003 executed if it is determined at step S1001 that the drag operation has not been made (NO) or after the process of step S1002, of determining whether or not the first press is maintained.

The program further includes a step S1004, executed if it is determined at step S1003 that the first press is maintained (YES), of determining whether or not preview image 3102 has reached an end portion of the screen image. If it is determined that preview image 3102 has not yet reached the end portion of screen image at step S1004 (NO), the control returns to step S1001.

The program further includes a step S1005, executed if it is determined at step S1004 that preview image 3102 has reached the end portion of screen image (YES), of determining whether or not there is a second press. Here, the second press refers to the user pressing a background portion of preview image 3102 that is kept pressed (the area including a plurality of preview images 3102 except for the preview image 3102 of the pressed state) while the first press is maintained. If it is determined at step S1005 that the second press is absent (NO), the control returns to step S1001.

The program further includes: a step S1006, executed if it is determined at step S1005 that there is a second press (YES), of determining whether or not a flick operation has been made on the background portion of preview image 3102 of the pressed state; and a step S1007, executed if it is determined at step S1006 that the flick operation has been made (YES), of scrolling the background portion of preview image 3102. The direction, speed, amount and duration of scrolling at step S1007 are determined based on the velocity (direction and speed) of flick operation detected by touch-panel 134. If it is determined at step S1006 that the flick operation has not been made (NO) at step S1006 or after the process of step S1007, the control returns to step S1005. At step S1007, of the direction, speed, amount and duration of scrolling, a meaningful combination may be determined arbitrarily. Here, the “speed” generally refers to an initial speed of the image at the start of movement. After the scrolling starts at this initial speed, it is preferred to decrease the speed of movement of the image at a prescribed acceleration. When the initial speed of image movement is determined and thereafter the speed is to be decreased, the amount and duration of scrolling are determined automatically, by calculating the time when the speed attains to 0. Therefore, it is not particularly necessary to determine these values at step S1007. On the other hand, if the initial speed of image movement and the amount or duration of scrolling are determined at the start based on the velocity of flick operation, the acceleration for decreasing the speed can also be calculated. It is naturally possible not to decrease the speed of scrolling. Here, only the amount of duration of scrolling may be determined, or scrolling may be continued until some operation is made by the user.

The program further includes a step S1008, executed if it is determined at step S1003 that the first press is not maintained (NO), of inserting the preview image 3102 that has been pressed to the position where the preview image 3102 is displayed currently, in the background of preview image 3102, and thereby to fix the position of preview image 3102. With this movement, the order of arrangement of the data of read images corresponding to the preview images 3102 stored in the storage device is also updated. After the process of step S1008, the control returns to step S1000.

The program further includes: a step S1009, executed if it is determined at step S1000 that there is no first press (NO), of determining whether or not cancellation of image edition mode has been requested; and a step S1010, executed if it is determined at step S1009 that cancellation of image edition mode has been requested (YES), of cancelling the image edition mode. If it is determined at step S1009 that cancellation of image edition mode is not requested (NO), the control returns to step S1000.

<Operation>

Referring to FIGS. 1 to 12, image forming apparatus 100 operates in the following manner. General operations of image forming apparatus 100 other than the operation described below are the same as those of a conventional image forming apparatus.

The user presses home key 148 on display operation unit 140. When home key 148 is pressed, the home screen image (not shown) is displayed on display panel 132. The user touches an icon for selecting the copy mode, displayed on the home screen image. In response to the touch operation, copy mode basic screen image 7100 (see FIG. 5) is displayed on display panel 132. The user places a plurality of documents on the ADF, and touches scan-in key 5102 displayed in task trigger area 5000. When the scan-in key 5102 is touched, the scan-in process described above is executed, and in preview area 3000, one page among the preview images 3102 of a plurality of pages based on a plurality of scan data is displayed.

The user wants to edit images of the plurality of preview images 3102, and touches edition key 3104 displayed on copy mode basic screen image 7100. When edition key 3104 is touched, image edition mode screen image 7300 (see FIG. 6) is displayed on display panel 132.

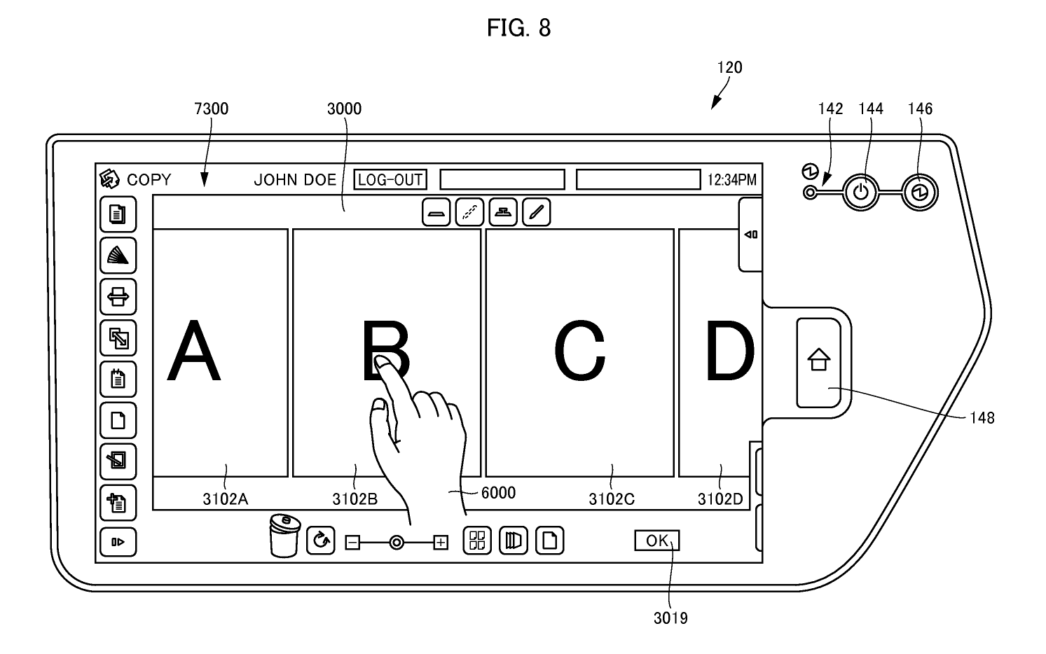

Referring to FIG. 8, the user confirms the image edition mode screen image 7300, selects a desired preview image 3102B from among the preview images of a plurality of pages displayed on preview area 3000, and presses the selected image with the index finger of his/her right hand 6000. Then, CPU 300 determines that there is a first press (YES at step S1000).

(Operation when a Desired Insertion Position is not Displayed on the Background of Pressed Preview Image 3102B)

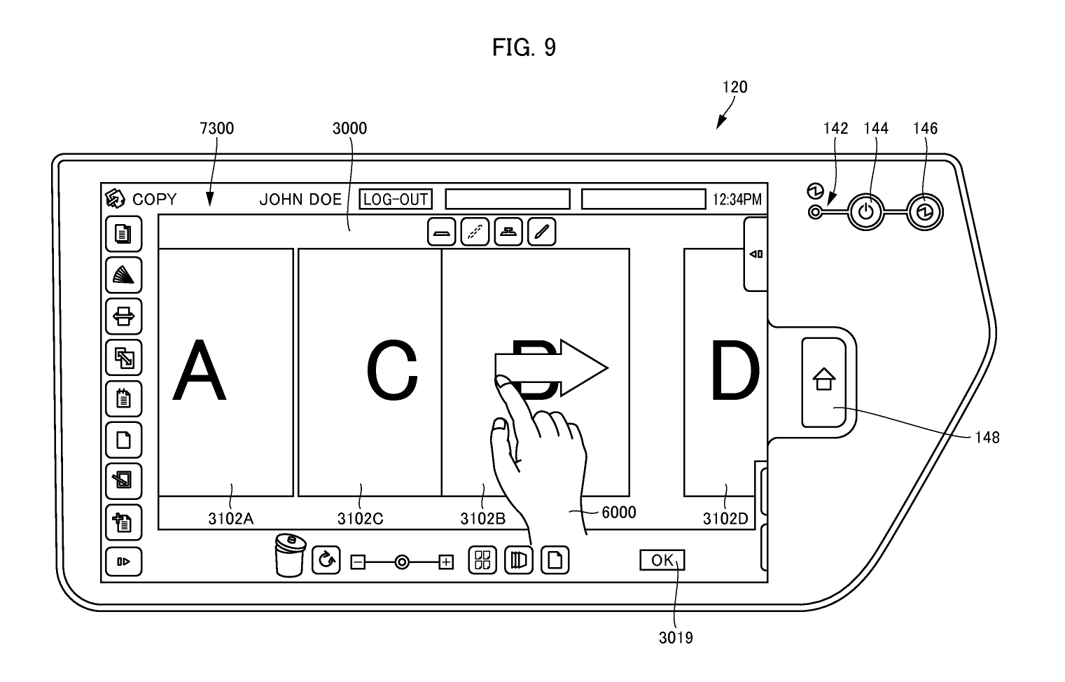

Referring to FIG. 9, the user moves the index finger of his/her right hand 6000 to the right of the screen image while pressing preview image 3102B. As the finger moves, CPU 300 determines that a drag operation has been made (YES at step S1001), and in accordance with the trajectory of dragging, moves the preview image 3102B of the pressed page (step S1002). Here, in preview area 3000, as the preview image 3102B moves to the right of the screen image, preview images 3102C, 3102D and so on following preview image 3102B are displayed carried forward one page by one page. While it is determined that the first press is maintained (YES at step S1003) and the preview image 3102B has not yet reached the end portion of screen image (NO at step S1004), CPU 300 repeats the moving operation of preview image 3102B described above (steps S1001, S1002).

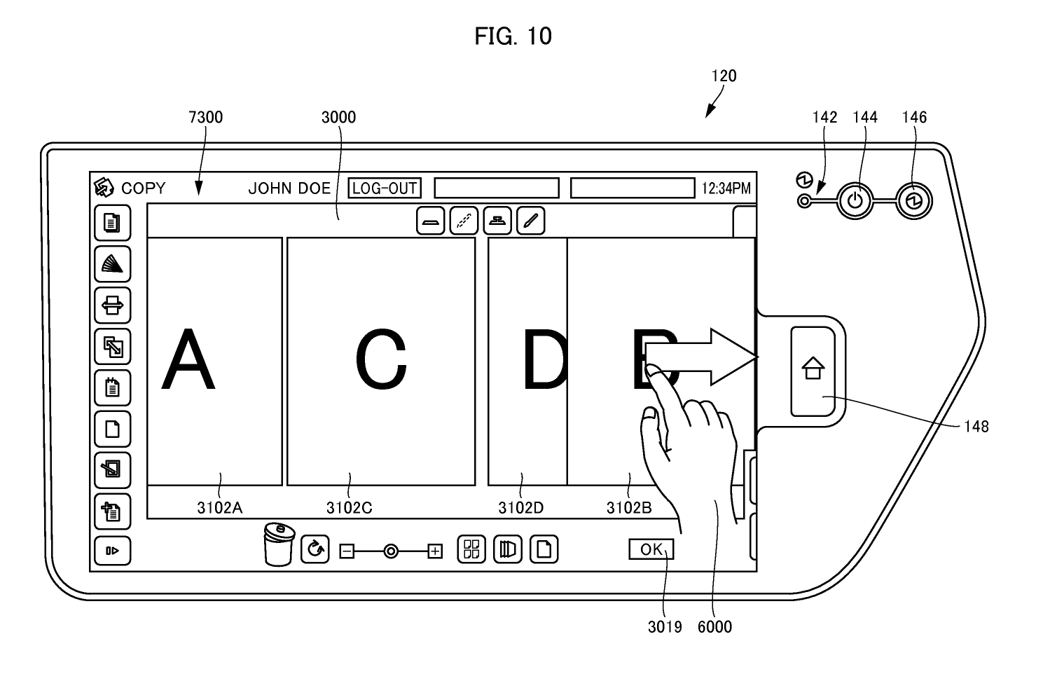

Referring to FIG. 10, after the user moves preview image 3102B to the right end of screen image, he/she stops dragging operation while he/she continues to press preview image 3102B. CPU 300 determines that the first press is maintained (YES at step S1003), and determines that preview image 3102B has reached an end portion of the screen image (YES at step S1004).

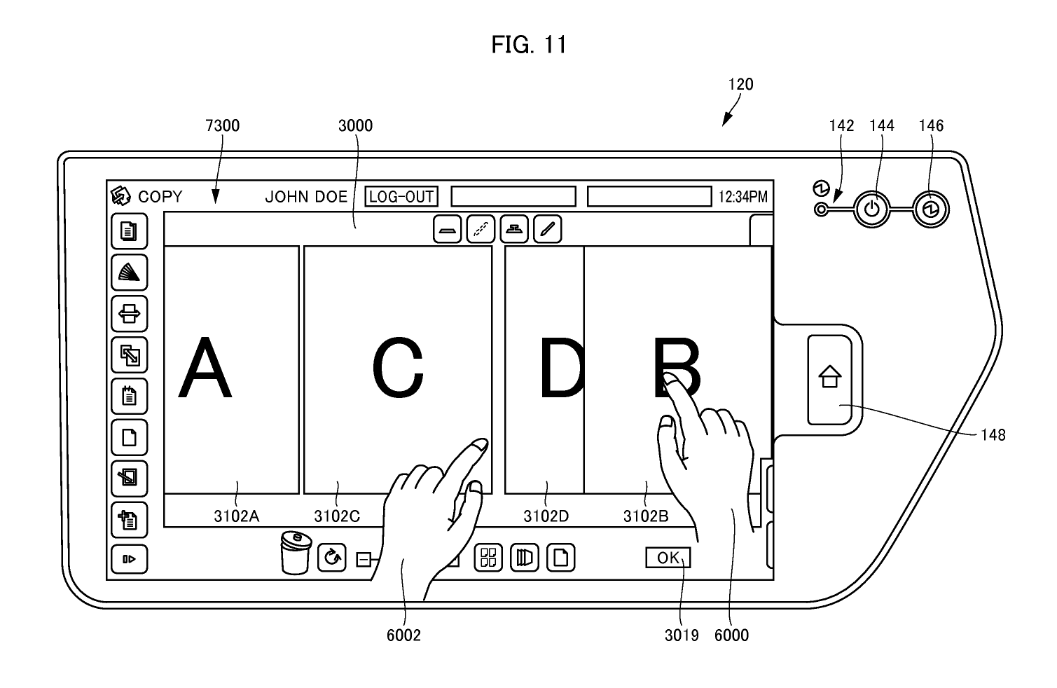

Referring to FIG. 11, the user presses a background portion of preview image 3102B with the index finger of his/her left hand 6002, while continuously pressing the preview image 3102B at the right end of screen image with the index finger of his/her right hand 6000. When the background portion is pressed, CPU 300 determines that there is the second press (YES at step S1005).

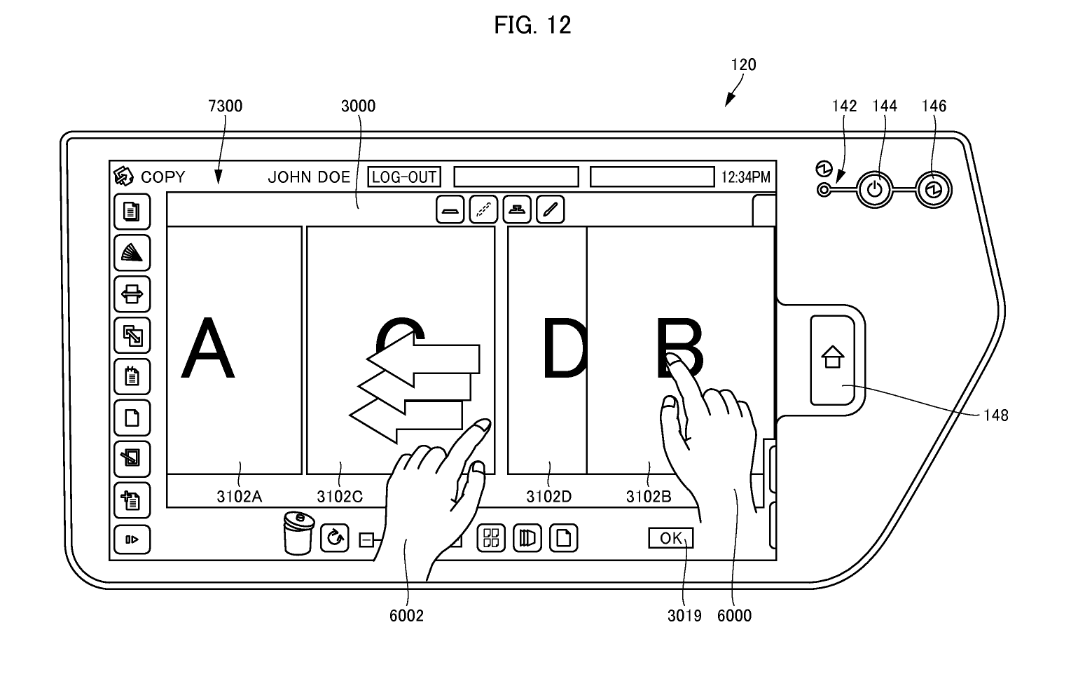

Referring to FIG. 12, the user lightly sweeps (flicks) the background portion to the left of the screen image once or a few times, with the tip of index finger of his/her left hand 6002. As the finger moves, CPU 300 determines that a flick operation has been made (YES at step S1006), and scrolls the background portion of preview image 3102B that is pressed (step S1007). At this time, the direction and speed of scrolling are determined based on the direction and speed of flick operation detected by touch-panel 134. The user repeats the flick operation described above until a desired position of insertion is displayed on the background portion (steps S1005 to S1007).

When the desired position of insertion is displayed on the background portion, the user stops the flick operation. When the finger moves away from the screen images and the flick operation stops, CPU 300 determines that the second press is absent (NO at step S1005).

After the flick operation is stopped, the user moves the index finger of his/her right hand 6000 away from the area where preview image 3102B is displayed. As the finger moves away from the screen image, CPU 300 determines that the drag operation is not done (NO at step S1001) and that the first press is not maintained (NO at step S1003), and fixes the position of preview image 3102B (step S1008). Specifically, CPU 300 fixes the preview image 3102B that has been pressed on the position where the preview image 3102B is currently displayed, on the background portion of preview image 3102B. As a result, the position of preview image 3102B among the arrangement of preview images is established.

(Operation when a Desired Insertion Position is Displayed on the Background of Pressed Preview Image 3102B)

Referring to FIG. 9, the user moves the index finger of his/her right hand 6000 to the right of the screen image while pressing preview image 3102B. As the finger moves, CPU 300 determines that a drag operation has been made (YES at step S1001), and in accordance with the trajectory of dragging, moves the preview image 3102B of the pressed page (step S1002). While it is determined that the first press is maintained (YES at step S1003) and the preview image 3102B has not yet reached the end portion of screen image (NO at step S1004), CPU 300 repeats the moving operation of preview image 3102B described above (steps S1001, S1002).

After moving the preview image 3102B to the desired position of insertion, the user stops the dragging operation and moves the index finger of his/her right hand 6000 away from preview image 3102B. As the finger moves away from the screen image, CPU 300 determines that the first press is not maintained (NO at step S1005), and CPU 300 inserts preview image 3102B that has been pressed between the two preview images displayed on both sides of the position where the preview image 3102B is currently displayed. In this manner, the position of preview image 3102B is fixed (step S1008). Thus, the user can change the order of arrangement of image data page by page.

After the desired image edition is done by operating various image edition keys 3030 to 3034 and the like displayed on image edition mode screen image 7300, the user touches OK key 3019 displayed on preview area 3000. When OK key 3019 is touched, CPU 300 determines that the first press is absent (NO at step S1000) and that cancellation of image edition mode is requested (YES at S1009), and cancels the image edition mode (step S1010). When the image edition mode is canceled, the copy mode basic screen image (see FIG. 5) is displayed on display panel 132.

The user sets various functions and parameters in the copy mode, and thereafter, touches monochrome start key 5106 or color start key 5108 displayed in task trigger area 5000. When monochrome start key 5160 or color start key 5108 is touched, the monochrome copy process or color copy process after scan-in process described above is executed.

[First Modification]

The first modification of the embodiment of the present invention is the same as the embodiment described above except that the process of step 1004 is omitted in the page order changing process (see FIG. 7).

<Operation>

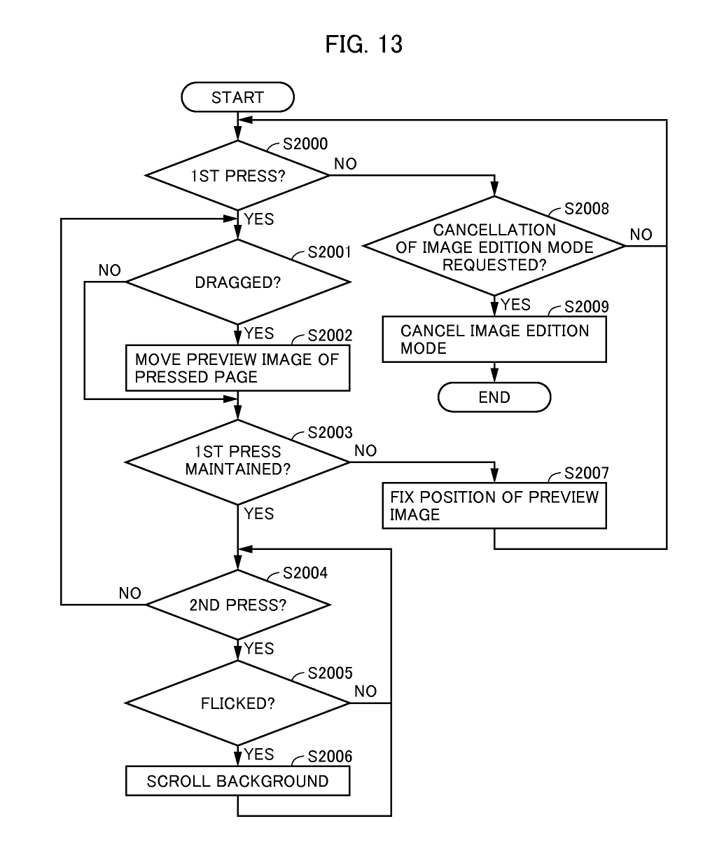

Referring to FIGS. 8, 9 and 13, image forming apparatus 100 in accordance with the present modification operates in the following manner. The operations of image forming apparatus 100 other than the operation below are the same as those of image forming apparatus 100 of the embodiment described above.

Referring to FIG. 8, the user confirms the image edition mode screen image 7300, and among the preview images 3102A to 3102D of the plurality of pages displayed on preview area 3000, he/she presses the preview image 3102B of the desired page with the index finger of his/her right hand 6000. The pressed preview image 3102B is set to the selected state. When preview image 3102B is pressed, CPU 300 determines that there is the first press (YES at step S2000).

(Operation when a Desired Insertion Position is not Displayed on the Background of Pressed Preview Image 3102B)

Referring to FIG. 9, the user moves the index finger of his/her right hand 6000 to the right of the screen image while pressing preview image 3102B. As the finger moves, CPU 300 determines that a drag operation has been made (YES at step S2001), and in accordance with the trajectory of dragging, moves the preview image 3102B of the pressed page (step S2002). Here, in preview area 3000, as the preview image 3102B moves to the right of the screen image, preview images 3102C, 3102D and so on following preview image 3102B are displayed carried forward one page by one page. Specifically, these preview images 3102C, 3102D and so on are moved one by one to the left side of preview image 3102B. While it is determined that the first press is maintained (YES at step S2003) and the second press is absent (NO at step S2004), CPU 300 repeats the moving operation of preview image 3102B described above (steps S2001, S2002).

After the user moves preview image 3102B to a desired position, he/she stops the dragging operation while maintaining pressing of preview image 3102B. By this operation, preview image 3102B is displayed stationary at this position while it is kept pressed. The user further presses a background portion of preview image 3102B with the index finger of his/her left hand 6002 while continuously pressing preview image 3102B with the index finger of his/her right hand 6000. CPU 300 determines that the first press is maintained (YES at step S2003) and that there is a second press (YES at step S2004).

The user lightly sweeps the background portion to the left of the screen image once or a few times, with the tip of index finger of his/her left hand 6002. When the finger movement is detected by the output of touch-panel 134, CPU 300 determines that a flick operation has been made (YES at step S2005), and scrolls the background portion of pressed preview image 3102B (step S2006). At this time, the direction and speed of scrolling are determined based on the direction and speed of flick operation detected by touch-panel 134. During this time, preview image 3102B is not scrolled but displayed stationary. The user repeats the flick operation mentioned above until the desired position of insertion is displayed on the background portion (steps S2004 to S2006).

When the desired position of insertion is displayed on the background portion, the user stops the flick operation. When the flick operation stops, CPU 300 determines that the second press is absent (NO at step S2004).

After the flick operation is stopped, the user moves the index finger of his/her right hand 6000 away from preview image 3102B. As the finger moves away from the screen image, CPU 300 determines that the drag operation is not done (NO at step S2001) and that the first press is not maintained (NO at step S2003), and inserts the preview image 3102B that has been pressed to the position where preview image 3102B is currently displayed, on the background portion of preview image 3102B. By this process, the position of preview image 3102B is fixed (step S2007).

Though the second press is made after the user stops the movement of preview image 3102B in the foregoing, similar operation is executed even if the second press is made while preview image 3102B is continuously moved.

[Second Modification]

The second modification of the embodiment of the present invention is the same as the embodiment described above except that part of the page order changing process (see FIG. 7) is different.

<Software Configuration>

(Page Order Changing Process)

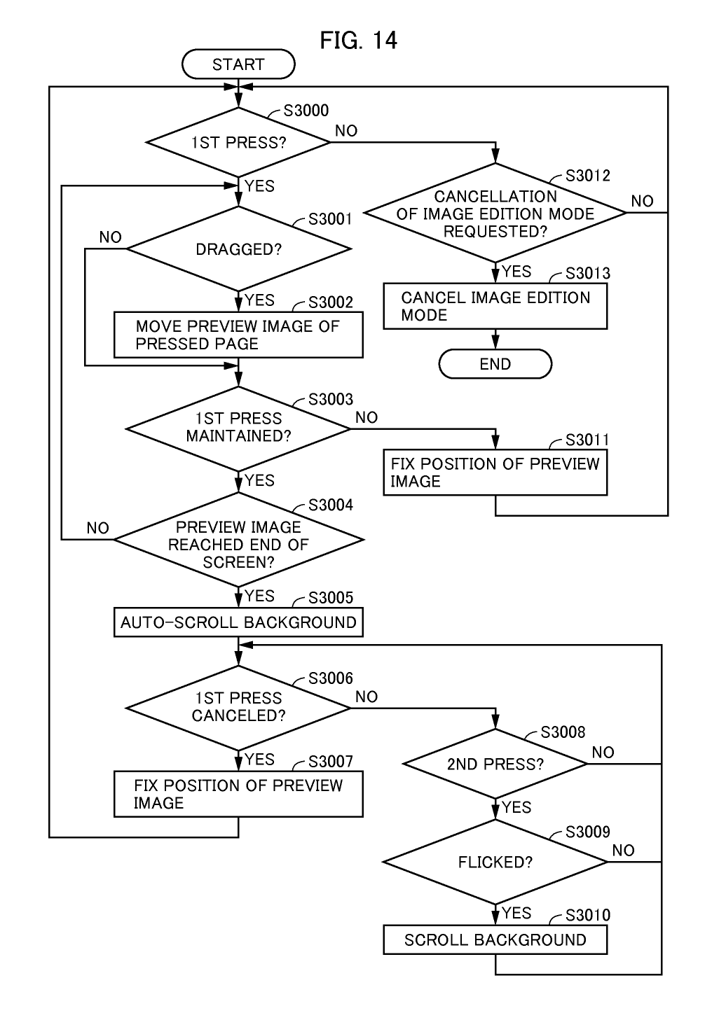

Referring to FIG. 14, in the program for realizing the page order changing process in accordance with the present modification, the process of steps S3000 to S3004 and steps S3011 to S3013 are the same as the process of steps S1000 to S1004 and steps S1008 to S1010. In the following, different process will be described.

The program includes: a step S3005, executed if it is determined at step S3004 that preview image 3102 has reached an end portion of screen image (YES), of automatically scrolling the background portion of preview image 3102 in a predetermined, prescribed direction at a predetermined, prescribed speed, while displaying the preview image 3102 fixed at that position; and a step S3006 of determining whether or not the first press has been canceled.

The program further includes: a step S3008, executed if it is determined at step S3006 that the first press is not canceled (NO), of determining whether there is the second press; a step S3009, executed if it is determined at step S3008 that there is the second press (YES), of determining whether or not a flick operation has been made; and a step S3010, executed if it is determined at step S3009 that the flick operation has been made (YES), of scrolling the background portion of preview image 3102. The direction and speed of scrolling at step S3010 are determined based on the direction and speed of flick operation detected by touch-panel 134. If it is determined at step S3008 that the second press is absent (NO), if it is determined at step S3009 that the flick operation has not been made (NO), or after the process of step S3010, the control returns to step S3006.

The program further includes a step S3007, executed if it is determined at step S3006 that the first press has been canceled (YES), of fixing the position of preview image 3102. Specifically, at this step, the preview image 3102 that has been pressed is inserted to the position where the preview image 3102 is currently displayed, of the background portion of preview image 3102. With this process, the order of arrangement of the image data as the source of preview images stored in the storage device is also changed. After the process of step S3007, the control returns to step S3000.

<Operation>

Referring to FIGS. 8 to 10 and 14, image forming apparatus 100 in accordance with the present modification operates in the following manner. The operations of image forming apparatus 100 in accordance with the modification except for the operation described below are the same as those of image forming apparatus 100 in accordance with the embodiment described above.

Referring to FIG. 8, the user confirms the image edition mode screen image 7300, selects a desired preview image 3102B from among the preview images 3102A to 3102D of a plurality of pages displayed on preview area 3000, and presses the selected image with the index finger of his/her right hand 6000. The preview image 3102B of the pressed portion is set to the selected state. When preview image 3102B is pressed, CPU 300 determines that there is the first press (YES at step S3000).

(Operation when a Desired Insertion Position is not Displayed on the Background of Pressed Preview Image 3102B)

Referring to FIG. 9, the user moves the index finger of his/her right hand 6000 to the right of the screen image while pressing preview image 3102B. As the finger moves, CPU 300 determines that a drag operation has been made (YES at step S3001), and in accordance with the trajectory of dragging, moves the preview image 3102B of the pressed page (step S3002). Here, in preview area 3000, as the preview image 3102B moves to the right of the screen image, preview images 3102C, 3102D and so on following preview image 3102B are displayed carried forward one page by one page. Specifically, these preview images 3102C, 3102D and so on are moved one by one to the left side of preview image 3102B. While it is determined that the first press is maintained (YES at step S3003) and the preview image 3102B has not yet reached the end portion of screen image (NO at step S3004), CPU 300 repeats the moving operation of preview image 3102B described above (steps S3001, S3002).

Referring to FIG. 10, when the user moves preview image 3102B to the right end portion of the screen image, he/she stops the dragging operation while continuously pressing preview image 3102B. CPU 300 determines that the first press is maintained (YES at step S3003) and preview image 3102B has reached the end portion of the screen image (YES at step S3004), and automatically scrolls the background portion of preview image 3102B in a predetermined, prescribed direction at a predetermined, prescribed speed (step S3005).

In order to have the background portion of preview image 3102B scrolled at a higher speed, the user may, for example, press the background portion of preview image 3102B that has been pressed, with the index finger of his/her left hand 6002, while continuously pressing the preview image 3102B at the right end portion of the screen image, with the index finger of his/her right hand 6000. When the background portion is pressed, CPU 300 determines that the first press is not cancelled (NO at step 3006), and determines that there is a second press (YES at step S3008).

The user lightly sweeps the background portion to the left of the screen image a few times, with the tip of index finger of his/her left hand 6002. When the finger movement mentioned above is made, CPU 300 determines that a flick operation has been made (YES at step S3009), and scrolls the background portion of preview image 3102B that is pressed (step S3010). Here, the direction and speed of scrolling are determined based on the direction and speed of flick operation detected by touch-panel 134. The user repeats the flick operation until the desired position of insertion appears on the background portion (steps S3006 to S3010).

When the desired position of insertion is displayed on the background portion, the user stops the flick operation. When the flick operation is stopped, CPU 300 determines that the second press is absent (NO at step S3008).

After the flick operation is stopped, the user moves the index finger of his/her right hand 6000 away from preview image 3102B. When the index finger of the right hand is moved away, CPU 300 determines that the first press is canceled (YES at step S3006), and inserts preview image 3102B that has been pressed to the position where the preview image 3102B is currently displayed, on the background portion of preview image 3102B. Thus, the position of preview image 3102B is fixed (step S3007).

<Functions/Effects>

According to the embodiment and modifications described above, operation unit 120 is provided with touch-panel display 130 including a display panel 132 for displaying a screen image and a touch-panel 134 arranged stacked on display panel 132, for receiving a user operation on the screen image. CPU 300 controlling touch-panel display 130 displays image edition mode screen image 7300 including preview images 3102 of a plurality of pages, displayed in a movable manner, on display panel 132. If it is determined that any of the plurality of preview images 3102 is in a selected state (first press) based on a user operation on touch-panel 134, whether or not an instruction for moving the plurality of preview images 3102 other than the preview image 3102 of the selected state (second press and flick operation) has been made is determined, based on a user operation on touch-panel 134. If it is determined that the instruction for moving has been given, the plurality of preview images 3102 other than the preview image 3102 of the selected state are scrolled. The direction and speed of scrolling the images other than the preview image of the selected state can be adjusted by the flick operation of the second press.

Consequently, when preview image 3102 displayed on image edition mode screen image 7300 of a small size is to be moved to a desired position, the process of moving preview image 3102 in a desired direction and the process of moving the background can be done separately in a simple manner. The direction and speed of movement of the background can be adjusted by the flick operation. As a result, preview image 3102 can be moved with high efficiency. Further, instructions related to the movement of displayed images can be issued using two fingers. Thus, convenience for the user can be improved.

According to the embodiment and the second modification thereof described above, if it is detected that any of the plurality of preview images 3102 is in a selected state, CPU determines whether or not the movement of selected preview image 3102 has been stopped at a predetermined, prescribed position (end portion of image edition mode screen image 7300), based on the user operation on touch-panel 134. If it is determined that the movement of selected preview image 3102 has been stopped at a predetermined, prescribed position (end portion of image edition mode screen image 7300), whether or not there is an instruction for moving images other than the preview image (second press and flick operation) is determined.

As described above, when the movement of selected preview image 3102 is stopped at a predetermined, prescribed position (end portion of image edition mode screen image 7300), whether or not an instruction for moving other images is issued is determined. Therefore, unintended scrolling of the plurality of preview images 3102 by an erroneous operation of the user can be prevented. Further, since the predetermined, prescribed position is an end portion of image edition mode screen image 7300, it is easy for the user to issue the instruction for moving described above through the operation on touch-panel 134. As a result, preview image 3102 can be moved with high efficiency.

Further, according to the second modification described above, if it is determined that the movement of selected preview image 3102 has been stopped at a predetermined, prescribed position (end portion of image edition mode screen image 7300), CPU 300 automatically scrolls the plurality of preview images 3102 other than the selected preview image 3102 in a predetermined, prescribed direction at a predetermined, prescribed speed. As a result, preview image 3102 can be moved with higher efficiency. Further, by determining the prescribed position in advance, automatic scrolling can be started with high efficiency.

Further, according to the embodiment and modifications described above, CPU 300 determines an arbitrary meaningful combination of direction, speed, amount and duration of scrolling, based on the user operation of touch-panel 134. Therefore, it is possible for the user to scroll the plurality of preview images 3102 other than the preview image of the selected state in the desired direction at a desired speed. Particularly if the speed of automatic scroll is too fast or too slow, it is possible to adjust the direction and speed of scrolling. Thus, convenience for the user can be improved.

Further, according to the embodiment described above, CPU 300 determines whether or not an instruction for moving has been given, based on a flick operation by the user on touch-panel 134. The velocity of flick operation is detected, and based on the detected velocity, the direction and speed of scrolling are determined. As a result, the user can easily scroll the plurality of preview images 3102 other than the selected preview image 3102 at a desired speed in a desired direction, independent from the movement of selected preview image 3102. Thus, convenience for the user can further be improved.

Further, according to the embodiment above, image forming apparatus 100 is provided with operation unit 120 including touch-panel display 130 and, therefore, the order of arrangement of preview images as the object of image formation can easily be changed. Thus, image forming apparatus highly convenient for the user can be provided.

### Other Embodiments

In the embodiment above, it has been assumed that the first and second presses are made by the index fingers of the right and left hands, respectively. The present invention, however, is not limited to such an embodiment. By way of example, pressing may be done by the index finger and the thumb of one's right hand, or may be realized not by fingers or thumbs. In short, any means that can designate two points on the screen image and can drag may be used to realize the same function as in the embodiment above.

Further, in the embodiment above, though the plurality of preview images 3102 are scrollable in the left/right direction of the screen image, the present invention is not limited to such an embodiment. The images may be scrollable in up/down direction of the screen image.

In the embodiment above, when the pressed preview image 3102B is stopped stationary at an end portion of the screen image, determination is made as to whether the instruction for moving (second press) is issued or not. The present invention, however, is not limited to such an embodiment. By way of example, determination as to whether the instruction for moving is given or not may be made while the pressed preview image 3102B is being moved. Alternatively, determination as to whether the instruction for moving is given or not may be made when the pressed preview image 3102B is stopped stationary at a position desired by the user. In this manner, the determination as to whether the instruction for moving is given or not is made while the movement of preview image 3102B of the selected state is stopped at a desired position and, therefore, unintended scrolling of the screen image by an erroneous operation by the user can be prevented. Thus, the images can be moved with high efficiency.

Though the page order changing process is done in the copy mode in the embodiment above, the present invention is not limited to such an embodiment. By way of example, the process may be executed in the FAX mode.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An operation console including a display device having a display screen, and a touch-panel arranged superposed on said display screen for receiving a user operation on said display screen, comprising:
a display control device controlling said display device such that a plurality of images are displayed on said display screen;
a detecting device detecting any of said plurality of images being selected, based on a user operation on said touch-panel;
a first determining device for determining, while selection of any of said plurality of images is being detected by said detecting device, whether or not an instruction for moving images other than said selected image among said plurality of images has been given, based on a user operation on said touch-panel; and
a scrolling device for scrolling and displaying the images other than said selected image among the plurality of images, in response to a determination by said first determining device that said instruction for moving has been given.

2. The operation console according to claim 1, further comprising
a second determining device for determining, while selection of any of said plurality of images is being detected by said detecting device, whether or not said selected image is displayed stationary, based on a user operation on said touch-panel; wherein
said first determining device determines whether or not said instruction for moving has been given, if it is determined by said second determining device that said selected image is displayed stationary.

3. The operation console according to claim 1, further comprising
a second determining device for determining, while selection of any of said plurality of images is being detected by said detecting device, whether or not said selected image is displayed stationary at a predetermined position, based on a user operation on said touch-panel; wherein
said first determining device determines whether or not said instruction for moving has been given, if it is determined by said second determining device that said selected image is displayed stationary at a predetermined position.

4. The operation console according to claim 3, wherein said predetermined position is an end portion of said display screen.

5. The operation console according to claim 3, further comprising an automatic scrolling device for scrolling the images other than said selected image among the plurality of images in a predetermined direction at a predetermined initial speed, if it is determined by said second determining device that said selected image is displayed stationary at said predetermined position.

6. The operation console according to claim 1, further comprising a deciding device deciding direction of scrolling, duration of scrolling, amount of scrolling or initial speed of scrolling by said scrolling device, based on a user operation on said touch-panel.

7. The operation console according to claim 6, wherein
the first determining device determines whether or not said instruction for moving has been given, based on a flick operation by the user on said touch-panel;
said operation console further comprising
a flick velocity detecting device for detecting velocity of the flick operation by the user on said touch-panel; wherein
said deciding device decides said initial speed of scrolling, duration of scrolling, amount of scrolling or said direction of scrolling, based on the velocity detected by said flick velocity detecting device.

8. The operation console according to claim 1, further comprising
a storage device for storing a plurality of image data items corresponding to said plurality of images in order; wherein
said display control device controls said display device such that said plurality of images are displayed on said display screen in an order in accordance with the order of corresponding image data items;
said operation console further comprising an order changing device, responsive to detection from an output of said detecting device that selection of the selected image is cancelled, for changing the order of storage of said plurality of image data items in said storage device, in accordance with the order of display arrangement of said plurality of images displayed on said display screen at that time.

9. An image forming apparatus, comprising
an operation console according to any of claims 1 to 8; and
an image forming unit processing an image data item and forming an image in accordance with an operation through said operation console.

10. A display method in an operation console including a display device having a display screen, and a touch-panel arranged superposed on said display screen for receiving a user operation on said display screen, comprising:
the display step of controlling said display device such that a plurality of images are displayed;
the detecting step of detecting any of said plurality of images being selected, based on a user operation on said touch-panel;
the determining step of determining, while selection of any of said plurality of images is being detected at said detecting step, whether or not an instruction for moving images other than said selected image has been given, based on a user operation on said touch-panel; and
the scrolling step of scrolling the images other than said selected image among the plurality of images, if it is determined at said determining step that said instruction for moving has been given.
